(19) United States
(12) Patent Application Publication
(10) Pub. No.: US 2006/0104176 A1
(43) Pub. Date: May 18, 2006

(54) Method of determining type of optical disc, and data recording and/or reproducing apparatus therefor

(75) Inventors: Byung-In Ma, Suwon-si (KR); Young-sam Lee, Incheon Metropolitian City (KR); Kwan-joon Kim, Hwaseong-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/246,522

(22) Filed: Oct. 11, 2005

(30) Foreign Application Priority Data
Nov. 12, 2004 (KR) 2004-92336

(51) Int. Cl. G11B 7/00

(52) U.S. Cl. 369/53.2; 369/275.1

(57) ABSTRACT

A method of determining a type of an optical disc loaded into a data recording and/or reproducing apparatus, which includes a plurality of laser diodes and records data onto and/or reproduces data from diverse types of optical discs, and the data recording and/or reproducing apparatus for implementing the method. The method includes selecting one laser diode from among the plurality of laser diodes, radiating light onto the loaded optical disc while approaching and/or withdrawing the selected laser diode to and from the loaded optical disc, counting a number of reflection signals generated from the light reflected from the loaded optical disc, and determining the type of the loaded optical disc based on the number of reflection signals.

### CROSS-REFERENCE TO RELATED PATENT APPLICATIONS

This application claims the benefit of Korean Patent Application No. 2004-92336, filed on Nov. 12, 2004, in the Korean Intellectual Property Office, the disclosure of which is incorporated herein by reference.

### BACKGROUND OF THE INVENTION

1. Field of the Invention

The present invention relates to a method of determining a type of optical disc, and more particularly, to a method of quickly and accurately determining a type of optical disc, and a data recording and/or reproducing apparatus incorporating the method.

2. Description of the Related Art

Various types of information storage media include magnetic discs such as floppy discs and hard discs, magnetic tapes, semiconductor memory chips such as read-only memory (ROM) and random access memory (RAM), and optical discs using a laser to record data.

As for optical discs, inexpensive storage capacity is rapidly increasing with the development of relevant technology. Thus, optical discs are very widely used. Optical discs may be divided into various types such as compact discs (CDs), digital video discs (DVDs), and Blu-ray discs (BDs) according to storage capacity.

Usually, a data recording and/or reproducing apparatus can record data onto and/or reproduce data from various types of optical discs. When an optical disc is loaded, a data recording and/or reproducing apparatus determines a type of the optical disc before writing data onto or reading data from the optical disc. The type of the optical disc may be exactly identified by reproducing data stored in a lead-in area on the optical disc, but the data recording and/or reproducing apparatus cannot reproduce data before identifying the type of the optical disc.

According to an example of conventional technology, a type of an optical disc is determined using a predetermined sequence. For example, when a sequence predetermined by a manufacturer of a data recording and/or reproducing apparatus is BD, DVD, and CD, the data recording and/or reproducing apparatus determines whether a loaded optical disc is a BD. To determine whether the optical disc is the BD, the data recording and/or reproducing apparatus sets various data including a power value of a laser diode corresponding to the BD. Thereafter, the data recording and/or reproducing apparatus determines whether the optical disc is the BD based on a signal obtained by radiating a laser beam onto the optical disc while moving an objective lens toward and away from the optical disc. However, if the optical disc is determined as not being the BD, the data recording and/or reproducing apparatus determines whether the optical disc is a DVD. Similarly to the above-described determining operation, the data recording and/or reproducing apparatus sets various data including the power value of a laser diode corresponding to the DVD and determines whether the optical disc is the DVD based on a signal obtained by radiating a laser beam onto the optical disc while moving the objective lens toward and away from the optical disc. If the optical disc is determined as not being the DVD, whether the optical disc is a CD is determined. If the optical disc is determined as not being a CD, the data recording and/or reproducing apparatus finally determines the optical disc as an unknown disc.

According to the conventional technology, since many operations are needed to determine a type of optical disc loaded into a data recording and/or reproducing apparatus, a type determination procedure for optical discs is complicated and takes time.

### SUMMARY OF THE INVENTION

An aspect of the present invention provides a method of quickly and accurately determining a type of optical disc loaded in a recording and/or reproducing apparatus.

An aspect of the present invention provides a data recording and/or reproducing apparatus for quickly and accurately determining a type of an optical disc loaded in the apparatus.

According to an aspect of the present invention, there is provided a method of determining a type of an optical disc loaded into a data recording and/or reproducing apparatus, which includes a plurality of laser diodes and records data onto and/or reproduces data from diverse types of optical discs. The method includes selecting one laser diode from among the plurality of laser diodes, radiating light onto the loaded optical disc while approaching and/or withdrawing the selected laser diode to and from the loaded optical disc, counting a number of reflection signals generated from the light reflected from the loaded optical disc, and determining the type of the loaded optical disc based on a number of the reflection signals.

The determining of the type of the loaded optical disc may be performed based on the number of reflection signals being different according to a distance between a surface and a data layer of the loaded optical disc and a working distance of the selected laser diode.

The determining of the type of the loaded optical disc may be performed based on whether there is a reflection signal from a data layer of the loaded optical disc.

The selecting of one laser diode may include selecting a laser diode having a shortest working distance among the plurality of laser diodes.

The loaded optical disc may be a compact disc, a digital video disc, or a Blu-ray disc. The number of reflection signals may be at least 2 when the loaded optical disc is the Blu-ray disc. The number of reflection signals may be 1 when the loaded optical disc is one of the compact disc and the digital video disc.

Where the loaded optical disc is determined as the compact disc or the digital video disc, the method may further include selecting another laser diode from among the plurality of laser diodes, radiating light onto the loaded optical disc while approaching and/or withdrawing the selected another laser diode to and from the loaded optical disc, and determining whether the loaded optical disc is the compact disc or the digital video disc based on a time interval between a reflection signal from a surface of the loaded optical disc and a reflection signal from a data layer of the loaded optical disc.

According to another aspect of the present invention, there is provided a data recording and/or reproducing apparatus which records data onto and/or reproduces data from diverse types of optical discs. The data recording and/or reproducing apparatus includes a writing/reading unit including a plurality of laser diodes and writing data to and/or reading data from an optical disc loaded into the data recording and/or reproducing apparatus; and a control unit selecting one laser diode from among the plurality of laser diodes, controlling the selected laser diode to radiate light onto the loaded optical disc while controlling the writing/reading unit to approach and/or withdraw from the loaded optical disc, and determining a type of the loaded optical disc based on a number of reflection signals generated from the light reflected from the loaded optical disc

The control unit may determine the type of the loaded optical disc based on the number of the reflection signals being different according to a distance between a surface of the loaded optical disc and a data layer of the loaded optical disc and a working distance of the selected laser diode.

The control unit may determine the type of the loaded optical disc based on whether there is a reflection signal from a data layer of the loaded optical disc.

The control unit may select a laser diode having a shortest working distance among the plurality of laser diodes.

The loaded optical disc may be a compact disc, a digital video disc, or a Blu-ray disc. The number of reflection signals may be at least 2 when the loaded optical disc is the Blu-ray disc. The number of reflection signals may be 1 when the loaded optical disc is the compact disc or the digital video disc.

When the loaded optical disc is determined as the compact disc or the digital video disc, the control unit may re-select another laser diode from among the plurality of laser diodes, control the re-selected another laser diode to radiate light onto the loaded optical disc while controlling the writing/reading unit to come close to and go away from the loaded optical disc, and determine the loaded optical disc is the compact disc or the digital video disc based on a time interval between a reflection signal from a surface of the loaded optical disc and a reflection signal from a data layer of the loaded optical disc.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A illustrates a cross-section of a Blu-ray disc (BD) with a single recording layer;

FIG. 1B illustrates a cross-section of a digital video disc (DVD) with a single recording layer;

FIG. 1C illustrates a cross-section of a compact disc (CD);

FIG. 2A illustrates a state where light is focused onto a data layer of an optical disc;

FIG. 2B illustrates a state where light is not focused onto a data layer of an optical disc;

FIG. 3A illustrates a case where a reflection signal obtained from light reflected from a surface of an optical disc and a reflection signal obtained from light reflected from a data layer of the optical disc are both present;

FIG. 3B illustrates a case where only a reflection signal obtained from light reflected from a surface of an optical disc is present;

FIG. 4 is a block diagram of a data recording and/or reproducing apparatus according to an embodiment of the present invention;

FIG. 5 is a flowchart of a method of determining a type of optical disc according to an embodiment of the present invention;

FIG. 6A illustrates a time interval between a reflection signal from a surface of a DVD and a reflection signal from a data layer of the DVD;

FIG. 6B illustrates a time interval between a reflection signal from a surface of a CD and a reflection signal from a data layer of the CD;

FIG. 7 is a flowchart of a method of determining a type of optical disc according to another embodiment of the present invention;

FIG. 8 is a block diagram of the writing/reading unit shown in FIG. 4; and

FIG. 9 is a block diagram of the control unit shown in FIG. 4.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

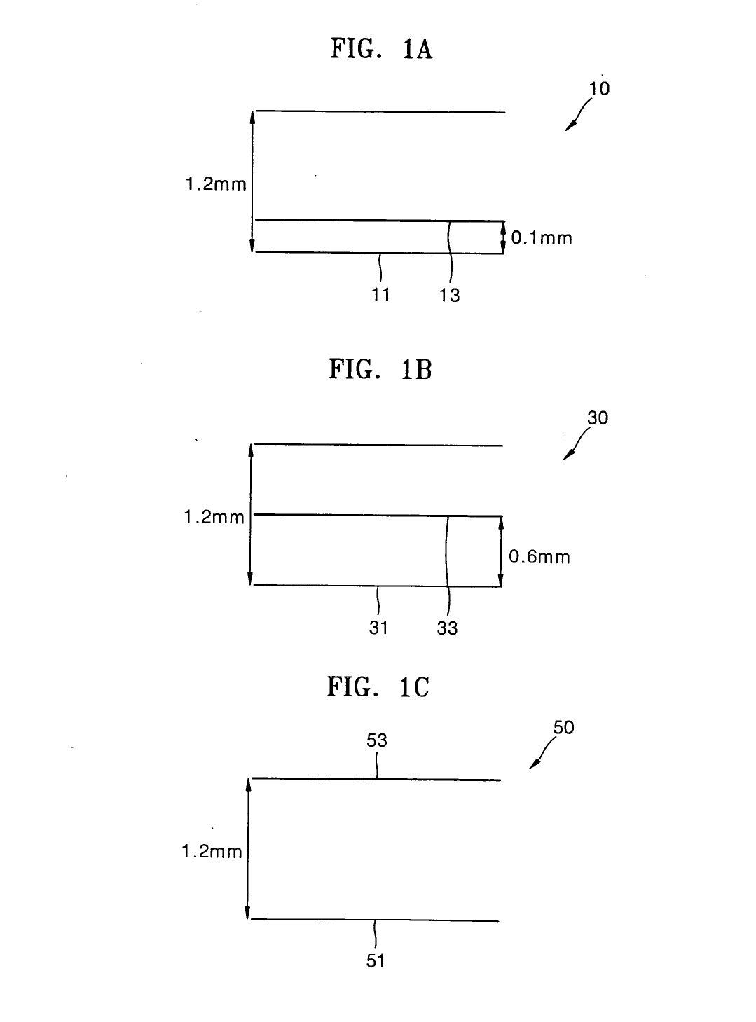

FIG. 1A illustrates a cross-section of a Blu-ray disc (BD) 10 with a single recording layer. The BD 10 is a next-generation high-density disc with a recording capacity of at least 15 Gbytes. Data is recorded onto the BD 10 using a blue laser diode generating 405-nm wavelength light. The BD 10 has a thickness of about 1.2 mm. A distance between a surface 11 and a data layer 13 of the BD 10 is about 0.1 mm.

FIG. 1B illustrates a cross-section of a digital video disc (DVD) 30 with a single recording layer. The DVD 30 has a thickness of about 1.2 mm like a BD and a compact disc (CD). A distance between a surface 31 and a data layer 33 of the DVD 30 is about 0.6 mm.

FIG. 1C illustrates a cross-section of a compact disc (CD) 50. A distance between a surface 51 and a data layer 53 of the CD 50 is about 1.2 mm.

As described above, the distance between a surface (11, 31, 51) and a data layer (13, 33, 53) increases in order of BD, DVD, and CD. A writing and/or reading unit provided in a data recording and/or reproducing apparatus, which can record data onto and/or reproduce data from various types of optical discs, includes a laser diode corresponding to each type of optical disc for which the recording and/or reproducing apparatus is useable. For example, a writing and/or reading unit provided in a data recording and/or reproducing apparatus that can record data onto and/or reproduce data from BDs, DVDs, and CDs includes three types of laser diodes, i.e., a BD laser diode, a DVD laser diode, and a CD laser diode.

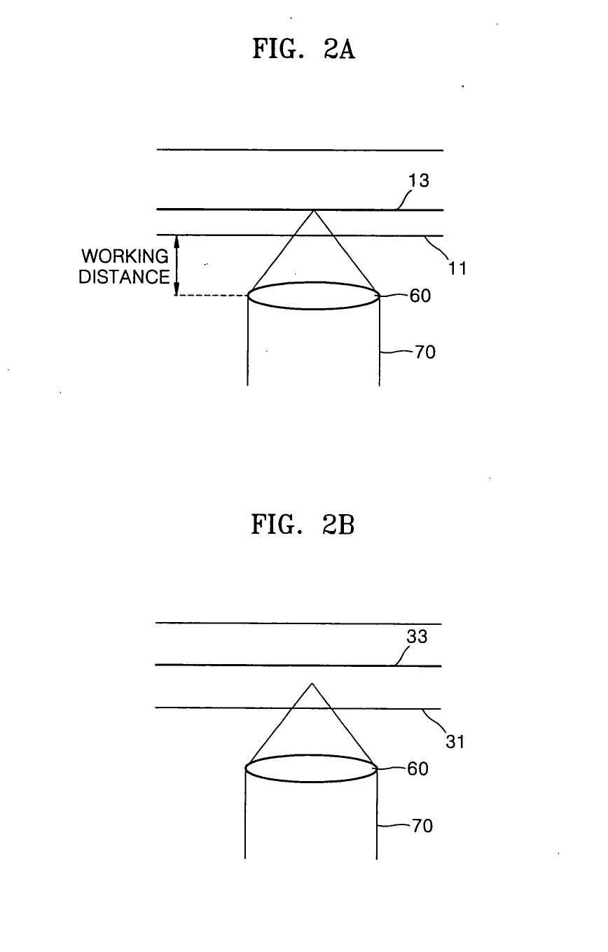

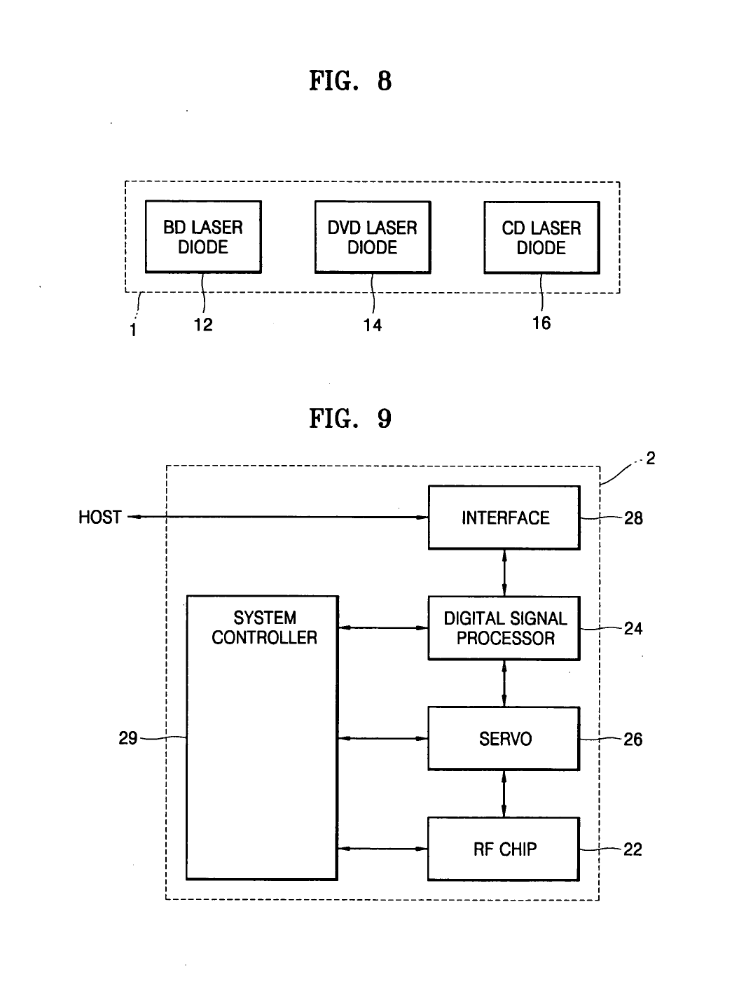

FIG. 2A illustrates a state where a light 70 emitted from a BD laser diode (FIG. 8) is focused by an objective lens 60 onto the data layer 13 of the BD 10. Here, a working distance is about 0.5 mm. Usually, a working distance is a distance between a surface of a disc and an objective lens when light is focused on a data layer of the disc.

FIG. 2B illustrates a state where the light 70 generated by the BD laser diode is radiated onto the DVD 30 via the objective lens 60. Since the working distance of the BD laser diode is about 0.5 mm and the distance between the surface 31 and the data layer 33 of the DVD 30 is about 0.6 mm, the light cannot be focused onto the data layer 33 of the DVD 30.

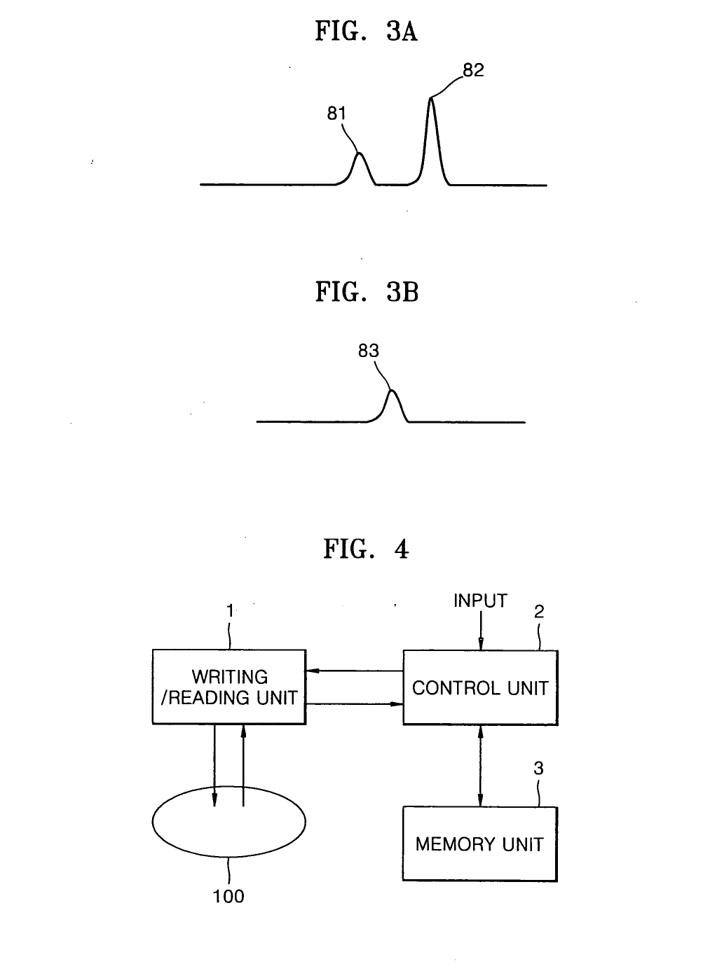

When the BD 10 is loaded into a data recording and/or reproducing apparatus and the data recording and/or reproducing apparatus turns on the BD laser diode and radiates light onto the BD 10 while moving the writing and/or reading unit toward and away from the optical disc, to focus the light, two reflection signals are obtained as shown in FIG. 3A. One is a reflection signal 81 obtained from light reflected from the surface 11 of the BD 10 and the other is a reflection signal 82 obtained from light reflected from the data layer 13 of the BD 10.

However, when the DVD 30 is loaded into a data recording and/or reproducing apparatus and the data recording and/or reproducing apparatus turns on the BD laser diode and radiates light onto the DVD 30 while moving the writing and/or reading unit toward and away from the optical disc, to focus the light, only one reflection signal 83 obtained from light reflected from the surface 31 of the DVD 30 is obtained as shown in FIG. 3B since no light is reflected from the data layer 33 of the DVD 30. When the CD 50 is loaded, similarly to the DVD 30, only a reflection signal obtained from light reflected from the surface 51 of the CD 50 is obtained in response to light radiated by the BD laser diode.

According to an aspect of the present invention, a type of an optical disc loaded into a data recording and/or reproducing apparatus is determined based on a number of reflection signals being different according to the distance between a surface and a data layer of the optical disc and the working distance of a laser diode. In other words, the type of the loaded optical disc may be determined based on whether there is a reflection signal from the data layer of the optical disc.

FIG. 4 is a block diagram of a data recording and/or reproducing apparatus according to an embodiment of the present invention. The data recording and/or reproducing apparatus includes a writing/reading unit 1, a control unit 2, and a memory unit 3.

The writing/reading unit 1 is controlled by the control unit 2 to write data to and/or read data from an optical disc 100. The writing/reading unit 1 includes laser diodes corresponding to various types of optical discs. In an embodiment of the present invention, the writing/reading unit 1 includes a BD laser diode 12, a DVD laser diode 14, and a CD laser diode 16, as shown in FIG. 8.

The control unit 2 controls the data recording and/or reproducing apparatus. As shown in FIG. 9, the control unit 2 includes a radio frequency (RF) chip 22 converting light reflected from the optical disc 100 into an RF signal, a digital signal processor (DSP) 24 performing channel decoding and error correction on the RF signal, a servo 26 performing focusing and tracking, an interface 28 for interface with a host, and a system controller 29 which controls overall operation of the control unit.

The memory unit 3 stores data read from the optical disc 100 and temporarily stores data to be written to the optical disc 100.

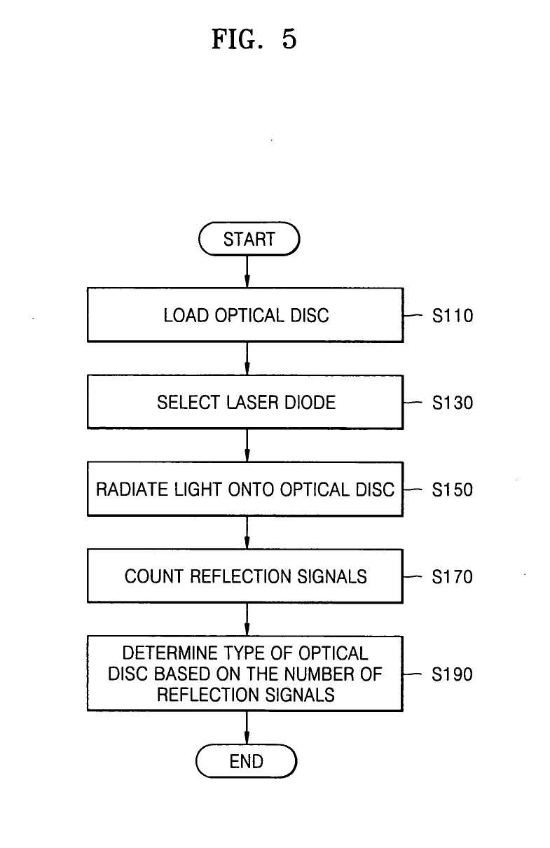

According to an embodiment of the present invention, a method of determining a type of optical disc, which is performed by the data recording and/or reproducing apparatus shown in FIG. 4, will be described with reference to FIG. 5.

Referring to FIG. 5, when the optical disc 100 is loaded into the data recording and/or reproducing apparatus at operation S110, the control unit 2 selects one of a plurality of laser diodes included in the writing/reading unit 1 at operation S130. In an embodiment of the present invention, the writing/reading unit 1 includes a DB laser diode, a DVD laser diode, and a CD laser diode. In embodiments of the present invention, a type of an optical disc loaded into the data recording and/or reproducing apparatus is determined based on a number of reflection signals being different according to the distance between a surface and a data layer of the optical disc and the working distance of a laser diode. In other words, the type of the loaded optical disc may be determined based on whether there is a reflection signal from the data layer of the optical disc. In an embodiment of the present invention, the control unit 2 selects the BD laser diode having a shortest working distance among the three laser diodes in operation S130.

Thereafter, in operation S150, the control unit 2 controls the BD laser diode to radiate light onto the optical disc 100 while controlling the writing/reading unit 1 to approach and/or withdraw from the optical disc 100. In operation S150, the data recording and/or reproducing apparatus operates in a focus search mode.

The control unit 2 counts reflection signals generated from light reflected from the optical disc 100 in operation S170 and determines the type of the optical disc 100 based on the number of reflection signals in operation S190. If the optical disc 100 is a BD with a single data layer, two reflection signals are obtained as shown in FIG. 3A. One is the reflection signal 81 obtained from light reflected from the surface 11 of the BD 10 and the other is the reflection signal 82 obtained from light reflected from the data layer 13 of the BD 10. However, if the optical disc 100 is a DVD or CD with a single data layer, only a reflection signal obtained from a surface of the optical disc 100 is obtained, as shown in FIG. 3B. If the optical disc 100 is a BD with two data layers, three reflection signals, i.e., one reflection signal obtained from light reflected from a surface of the BD and two reflection signals obtained from lights reflected from the two data layers, respectively, are obtained. In other words, in an embodiment of the present invention, when the number of reflection signals is at least 2, the optical disc 100 is determined as the BD.

When the optical disc 100 is determined as not being a BD in operation S190, it is needed to determine whether the optical disc 100 is a DVD or a CD. Determining whether the optical disc 100 is a DVD or a CD may be performed using conventional methods or according to an aspect of the present invention.

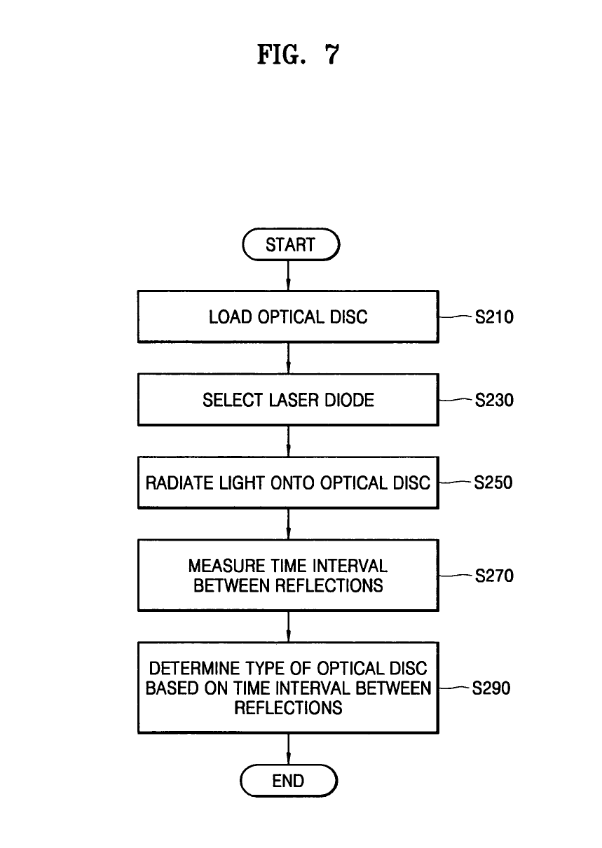

An example of a method of determining whether the optical disc 100 is a DVD or a CD according to an aspect of the present invention will now be described with respect to FIG. 7. The optical disc is loaded at operation S210. The control unit 2 selects the DVD laser diode or the CD laser diode at operation S230. For example, the control unit 2 selects and turns on the DVD laser diode 14 and controls the DVD laser diode 14 to radiate light onto the optical disc 100 at operation S250 while approaching and/or withdrawing the writing/reading unit 1 toward and away from the optical disc 100. In other words, a focus search operation is performed again. A time interval between reflections from the optical disc 100 is measured at operation S270. The control unit 2 determines whether the optical disc 100 is the DVD or the CD based on a time interval between a reflection signal from the surface (31, 51) of the optical disc 100 and a reflection signal from the data layer (33, 53) of the optical disc 100 at operation S290.

Referring to FIG. 1B, the distance between the surface 31 and the data layer 33 of the DVD 30 having the single data layer 33 is about 0.6 mm. Referring to FIG. 1C, the distance between the surface 51 and the data layer 53 of the CD 50 is about 1.2 mm. In other words, the distance between the surface 31 and the data layer 33 of the DVD 30 is shorter than the distance between the surface 51 and the data layer 53 of the CD 50. Accordingly, based on the time interval between the reflection signal from the surface of the optical disc 100 and the reflection signal from the data layer of the optical disc 100, whether the optical disc 100 is the CD or the DVD may be determined.

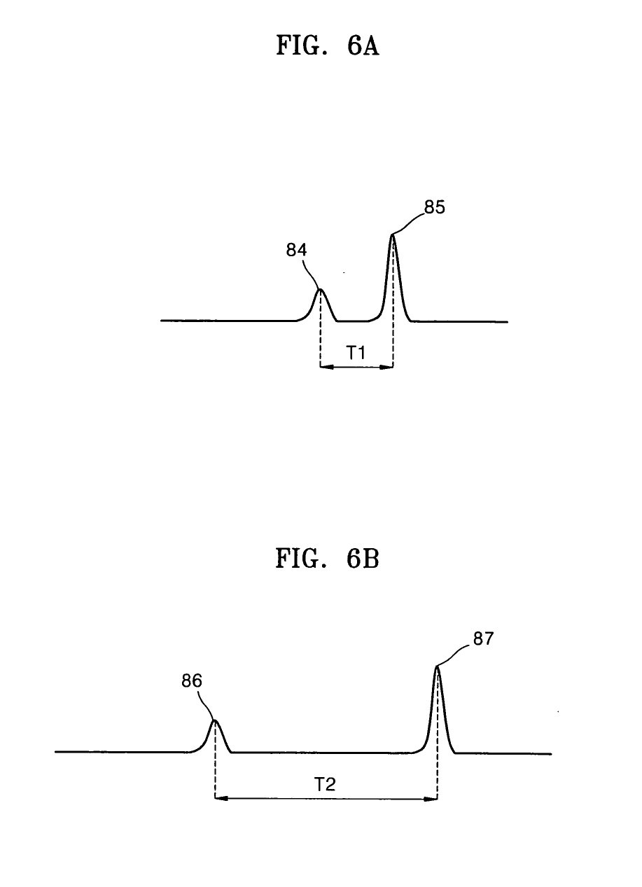

FIG. 6A illustrates a time interval T1 between a reflection signal 84 from the surface 31 of the DVD and a reflection signal 85 from the data layer 33 of the DVD. FIG. 6B illustrates a time interval T2 between a reflection signal 86 from the surface 51 of the CD and a reflection signal 87 from the data layer 53 of the CD. Since the distance between the surface 31 and the data layer 33 of the DVD 30 is shorter than the distance between the surface 51 and the data layer 53 of the CD 50, T1 is less than T2.

In the above embodiments, determining a type of the optical disc 100 as a BD, a DVD, or a CD has been described, but the present invention is not restricted thereto. The method and apparatus may be applied to distinguishing other types of discs having different thicknesses, different distances between a surface and a recording layer and operating at different working distances. In addition, the present invention is useable regardless of whether the optical disc 100 has a single data layer or multiple data layers.

The invention may also be embodied as computer readable codes on a computer readable recording medium. The computer readable recording medium may be any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium may also be distributed over network coupled computer systems so that the computer readable code is stored and executed in a distributed fashion.

As described above, according to aspects of the present invention, a type of an optical disc loaded into a data recording and/or reproducing apparatus may be quickly and accurately determined, and therefore, initialization time for the use of an optical disc is reduced.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of determining a type of an optical disc loaded into a data recording and/or reproducing apparatus, which includes a plurality of laser diodes and records data onto and/or reproduces data from diverse types of optical discs, the method comprising:
selecting one laser diode from among the plurality of laser diodes;
radiating light onto the loaded optical disc with the selected laser diode while approaching and/or withdrawing the selected laser diode to and from the loaded optical disc;
counting a number of reflection signals generated from light reflected from the loaded optical disc; and
determining the type of the loaded optical disc based on the number of reflection signals.

2. The method of claim 1, wherein the determining of the type of the loaded optical disc is based on the number of reflection signals being different according to a distance between a surface and a data layer of the loaded optical disc and a working distance of the selected laser diode.

3. The method of claim 1, wherein the determining of the type of the loaded optical disc is based on whether there is a reflection signal from a data layer of the loaded optical disc.

4. The method of claim 1, wherein the selecting of the one laser diode comprises selecting a laser diode having a shortest working distance among the plurality of laser diodes.

5. The method of claim 1, wherein:
where the loaded optical disc is a compact disc, a digital video disc, or a Blu-ray disc:
the number of reflection signals is at least 2 where the loaded optical disc is the Blu-ray disc, and
the number of reflection signals is 1 where the loaded optical disc is the compact disc or the digital video disc.

6. The method of claim 5, wherein:
where the loaded optical disc is determined as the compact disc or the digital video disc, the method further comprises:
selecting another laser diode from among the plurality of laser diodes;
radiating light onto the loaded optical disc while approaching and/or withdrawing the selected another laser diode to and from the loaded optical disc; and
determining whether the loaded optical disc is the compact disc or the digital video disc based on a time interval between a reflection signal from a surface of the loaded optical disc and a reflection signal from a data layer of the loaded optical disc.

7. A data recording and/or reproducing apparatus for recording data onto and/or reproducing data from diverse types of optical discs, the data recording and/or reproducing apparatus comprising:
a writing/reading unit including a plurality of laser diodes and writing data to and/or reading data from an optical disc loaded into the data recording and/or reproducing apparatus; and
a control unit:
selecting one laser diode from among the plurality of laser diodes,
controlling the selected laser diode to radiate light onto the loaded optical disc while controlling the writing/reading unit to approach and/or withdraw from the loaded optical disc, and
determining a type of the loaded optical disc based on a number of reflection signals generated from the light reflected from the loaded optical disc.

8. The data recording and/or reproducing apparatus of claim 7, wherein the control unit determines the type of the loaded optical disc based on the number of reflection signals being different according to a distance between a surface of the loaded optical disc and a data layer of the loaded optical disc and a working distance of the selected laser diode.

9. The data recording and/or reproducing apparatus of claim 7, wherein the control unit determines the type of the loaded optical disc based on whether there is a reflection signal from a data layer of the loaded optical disc.

10. The data recording and/or reproducing apparatus of claim 7, wherein the control unit selects the laser diode having a shortest working distance among the plurality of laser diodes.

11. The data recording and/or reproducing apparatus of claim 7, wherein:
where the loaded optical disc is a compact disc, a digital video disc, or a Blu-ray disc:
the number of reflection signals is at least 2 when the loaded optical disc is the Blu-ray disc, and
the number of reflection signals is 1 when the loaded optical disc is the compact disc or the digital video disc.

12. The data recording and/or reproducing apparatus of claim 10, wherein:
where the loaded optical disc is determined as the compact disc or the digital video disc, the control unit:
selects another laser diode from among the plurality of laser diodes,
controls the another laser diode to radiate light onto the loaded optical disc while controlling the writing/reading unit to approach and/or withdraw from the loaded optical disc, and
determines the type of the loaded optical disc as the compact disc or the digital video disc based on a time interval between a reflection signal from a surface of the loaded optical disc and a reflection signal from a data layer of the loaded optical disc.

13. A computer readable recording medium comprising a program for executing a method of determining a type of an optical disc loaded into a data recording and/or reproducing apparatus, which includes a plurality of laser diodes and records data onto and/or reproduces data from diverse types of optical discs, the computer readable recording medium comprising:
instructions for selecting one laser diode from among the plurality of laser diodes;
instruction for radiating light onto the loaded optical disc while approaching and/or withdrawing the selected laser diode to and from the loaded optical disc;
instructions for counting a number of reflection signals generated from the light reflected from the loaded optical disc; and
instructions for determining the type of the loaded optical disc based on the number of reflection signals.

14. The computer medium of claim 13, further comprising:
instructions for determining the type of the loaded optical disc based on the number of reflection signals being different according to a distance between a surface and a data layer of the loaded optical disc and a working distance of the selected laser diode.

15. The computer readable medium of claim 13, further comprising:
instructions for determining the type of the loaded optical disc based on whether there is a reflection signal from a data layer of the loaded optical disc.

16. The computer readable medium of claim 13, further comprising:
instructions for selecting the one laser diode having a shortest working distance among the plurality of laser diodes.

17. The computer readable medium of claim 16, further comprising:
instructions for determining that the loaded disc is a Blu-ray disc, if the number of reflection signals is at least 2; and
instructions for determining that the loaded disc is the compact disc or the digital video disc, if the number of the reflection signals is 1.

18. The computer readable medium of claim 17, further comprising:
instructions for selecting another laser diode from among the plurality of laser diodes, if the loaded optical disc is determined as the compact disc or the digital video disc;
instructions for radiating light onto the loaded optical disc while approaching and/or withdrawing the selected another laser diode to and from the loaded optical disc; and
instructions for determining whether the loaded optical disc is the compact disc or the digital video disc based on a time interval between a reflection signal from a surface of the loaded optical disc and a reflection signal from a data layer of the loaded optical disc.

19. The apparatus of claim 7, wherein the writing/reading unit comprises a BD laser diode, a DVD laser diode and a CD laser diode.

20. The apparatus of claim 7, wherein the a control comprises:
a radio frequency (RF) chip converting light reflected from the loaded optical disc into an RF signal,
a digital signal processor performing channel decoding and error correction on the RF signal,
a servo performing focusing and tracking,
an interface interfacing with a host, and
a system controller controlling overall operation of the control unit.

21. A method of determining a type of an optical disc loaded into a data recording and/or reproducing apparatus, the method comprising:
radiating light onto a loaded optical disc using a laser diode while varying a distance between the laser diode and a surface of the loaded optical disc; and
determining the type of the loaded optical disc based on a number of reflection signals generated from light reflected from the loaded optical disc.

22. A method of determining a type of an optical disc loaded into a data recording and/or reproducing apparatus, the method comprising:
radiating light onto a loaded optical disc using a laser diode while varying a distance between the laser diode and a surface of the loaded optical disc; and
determining the type of the loaded optical disc based on an elapsed time between reflection signals generated from light reflected from the loaded optical disc.

23. An apparatus for determining a type of an optical disc loaded in a data recording and/or reproducing apparatus, the apparatus comprising:
a writing/reading unit comprising a laser diode and movable to vary a distance between the laser diode and a surface of the loaded optical disc; and
a control unit which:
controls the laser diode to radiate light onto the loaded optical disc,
controls the variable movement of the reading/writing unit, and
determines a type of the loaded optical disc according to a number of reflection signals generated from light reflected from the loaded optical disc.

24. An apparatus for determining a type of an optical disc loaded in a data recording and/or reproducing apparatus, the apparatus comprising:
a writing/reading unit having a laser diode and movable to vary a distance between the laser diode and a surface of the optical disc; and
a control unit which:
controls the laser diode to radiate light onto the loaded optical disc,
controls the variable movement of the reading/writing unit, and
determines a type of the loaded optical disc according to an elapsed time between reflection signals generated from light reflected from the loaded optical disc.
